(19) United States
(12) Patent Application Publication
(10) Pub. No.: US 2018/0242674 A1
(43) Pub. Date: Aug. 30, 2018

(54) Illuminated Safety Helmet Assembly

(71) Applicant: Jerry Smith, Jacksonville, FL (US)

(72) Inventor: Jerry Smith, Jacksonville, FL (US)

(21) Appl. No.: 15/441,870

(22) Filed: Feb. 24, 2017

(51) Int. Cl. A42B 3/04; F21L 4/02; H05B 37/02; F21V 33/00; B60Q 1/26

(52) U.S. Cl. CPC A42B 3/0453; F21L 4/02; H05B 37/0272; F21Y 2115/10; A42B 3/044; B60Q 1/2676; F21V 33/0064

(57) ABSTRACT

An illuminated safety helmet assembly for indicating turns and braking includes a shell that is substantially complementary to a helmet. The helmet is configured to couple to a head of a user and the shell is configured to couple to the helmet. A first power module is coupled to the shell. A first light, positioned on a right side of the shell, and a second light, positioned on a left side of the shell, are coupled proximate to a back of the shell. A third light is coupled to and is centrally positioned on the back of the shell. A controller, coupled to the shell, is operationally coupled to the first power module, the first light, the second light, and the third light. The controller is configured to selectively operationally couple the first light, the second light, and the third light to the first power module.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

(1) Field of the Invention

(2) Description of Related Art Including Information Disclosed Under 37 CFR 1.97 and 1.98.

The disclosure and prior art relates to safety helmet assemblies and more particularly pertains to a new safety helmet assembly for indicating turns and braking.

### (h) BRIEF SUMMARY OF THE INVENTION

An embodiment of the disclosure meets the needs presented above by generally comprising a shell that is substantially complementary to a helmet. The helmet is configured to couple to a head of a user and the shell is configured to couple to the helmet. A first power module is coupled to the shell. A first light, positioned on a right side of the shell, and a second light, positioned on a left side of the shell, are coupled proximate to a back of the shell. A third light is coupled to and is centrally positioned on the back of the shell. A controller, coupled to the shell, is operationally coupled to the first power module, the first light, the second light, and the third light. The controller is configured to selectively operationally couple the first light, the second light, and the third light to the first power module to indicate braking and the user's intent to execute right turns and left turns.

There has thus been outlined, rather broadly, the more important features of the disclosure in order that the detailed description thereof that follows may be better understood, and in order that the present contribution to the art may be better appreciated.

There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of an illuminated safety helmet assembly according to an embodiment of the disclosure.

FIG. 2 is a back view of an embodiment of the disclosure.

FIG. 3 is a side view of an embodiment of the disclosure.

FIG. 4 is a top view of an embodiment of the disclosure.

FIG. 5 is a top view of an embodiment of the disclosure.

### (j) DETAILED DESCRIPTION OF THE INVENTION

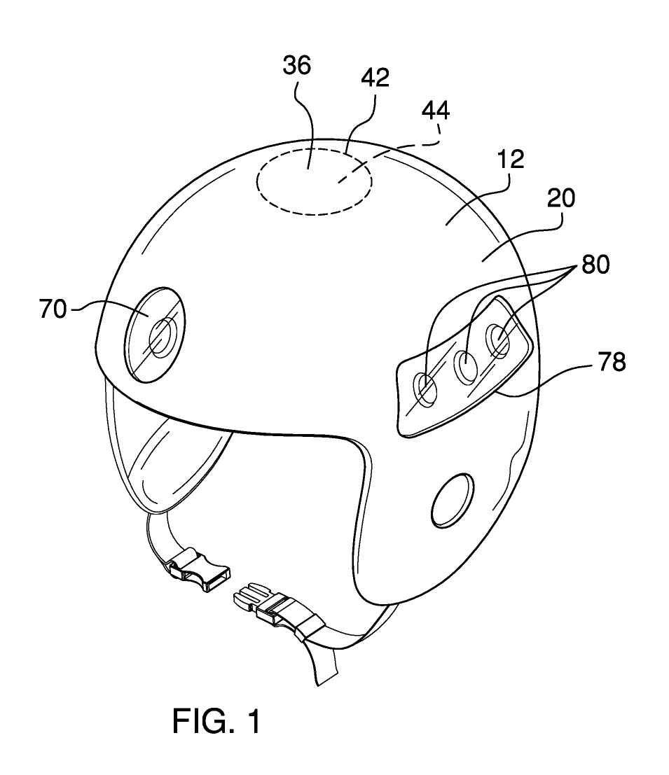

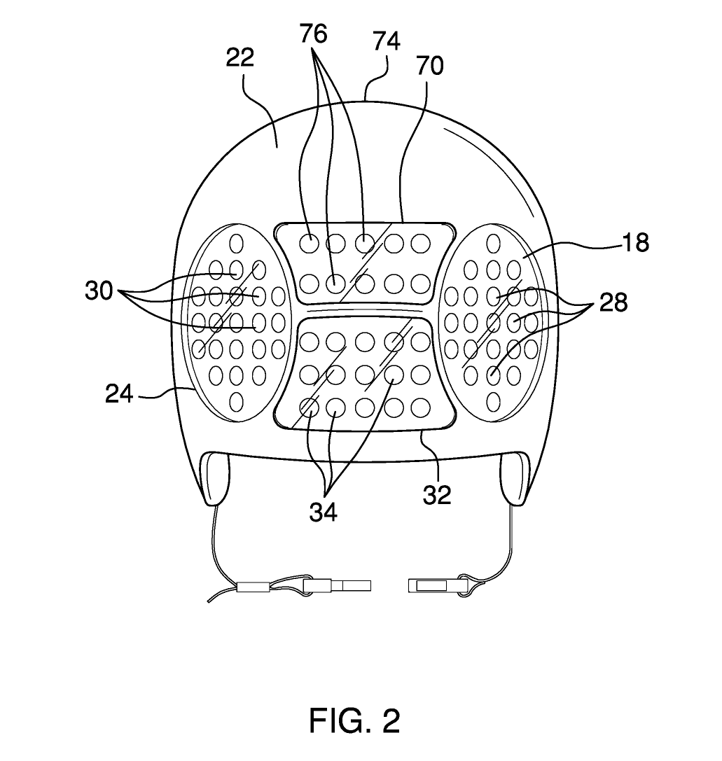

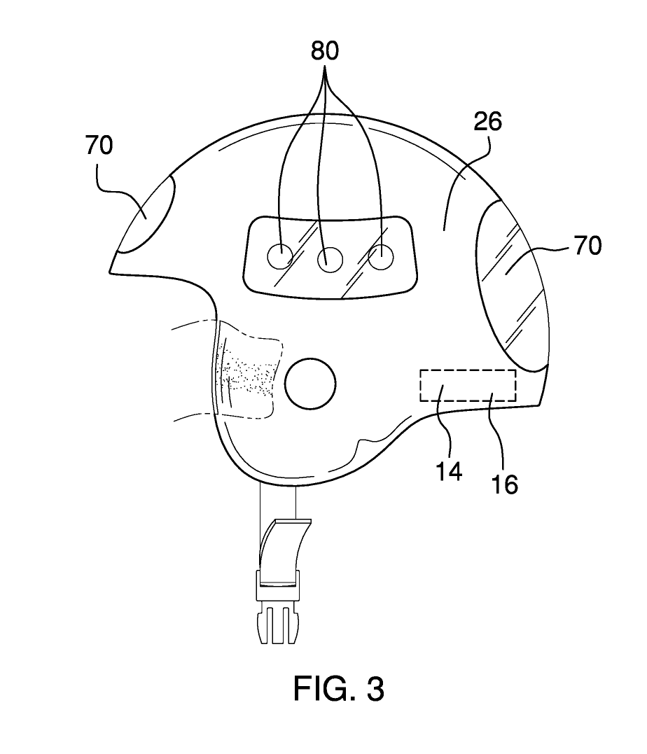

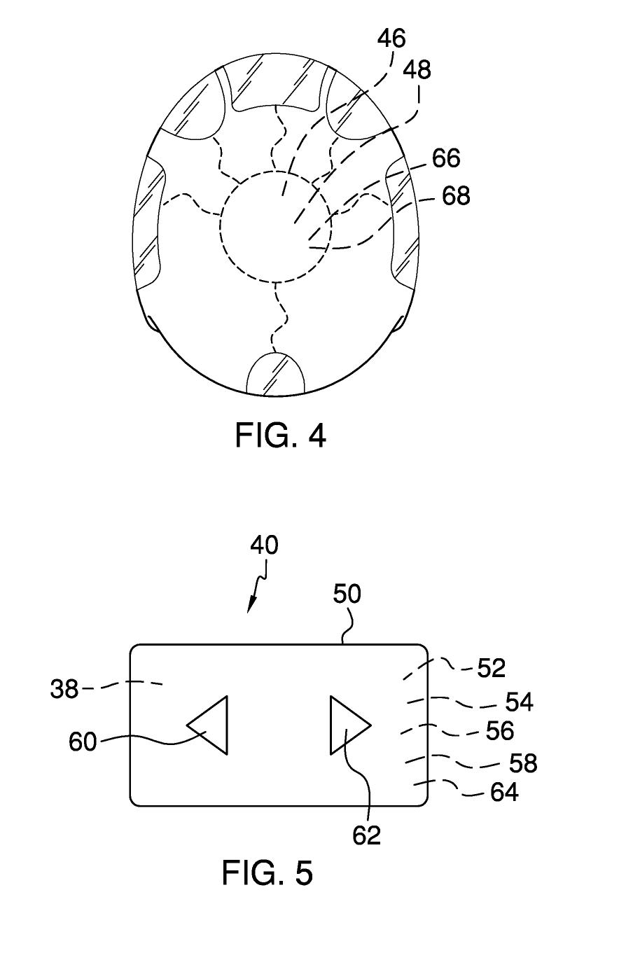

With reference now to the drawings, and in particular to FIGS. 1 through 5 thereof, a new safety helmet assembly embodying the principles and concepts of an embodiment of the disclosure and generally designated by the reference numeral 10 will be described.

As best illustrated in FIGS. 1 through 5, the illuminated safety helmet assembly 10 generally comprises a shell 12 that is substantially complementary to a helmet. The helmet is configured to couple to a head of a user. The shell 12 is configured to couple to the helmet. In one embodiment, the shell 12 is integral to the helmet.

A first power module 14 is coupled to the shell 12. In one embodiment, the first power module 14 comprises at least one first battery 16. A first light 18 is coupled to and is positioned on a right side 20 of the shell 12 proximate to a back 22 of the shell 12. A second light 24 is coupled to and is positioned on a left side 26 of the shell 12 proximate to the back 22 of the shell 12. The first light 18 and the second light 24 are configured to intermittently illuminate. In one embodiment, the first light 18 and the second light 24 are yellow. In another embodiment, the first light 18 comprises a plurality of first light emitting diodes 28 and the second light 24 comprises a plurality of second light emitting diodes 30.

A third light 32 is coupled to and is centrally positioned on the back 22 of the shell 12. In one embodiment, the third light 32 is red. In another embodiment, the third light 32 comprises a plurality of third light emitting diodes 34.

A controller 36 is coupled to the shell 12. The controller 36 is operationally coupled to the first power module 14, the first light 18, the second light 24, and the third light 32. The controller 36 is configured to receive commands from the user. The controller 36 is positioned to selectively operationally couple the first light 18, the second light 24, and the third light 32 to the first power module 14. The user is positioned to selectively indicate the user's intent to execute right turns and left turns. Braking of a vehicle that is being operated by the user, such as a velocipede, is indicated to persons approaching the user from behind.

In one embodiment, the assembly 10 comprises a sensor 38 and a control module 40 that are configured to couple to the vehicle. The sensor 38 is configured to operationally couple to a brake system of the vehicle. The sensor 38 is configured to detect activation of the brake system of the vehicle. The control module 40 is operationally coupled to the sensor 38. The control module 40 is configured to allow the user to selectively input requests to couple of the first light 18 and the second light 24 to the first power module 14. The control module 40 is configured to communicate with the controller 36. The control module 40 is positioned to receive input from the sensor 38 upon the sensor 38 detecting the activation of the brake system of the vehicle. The control module 40 is positioned to communicate the activation of the brake system of the vehicle to the controller 36. The controller 36 is positioned to selectively operationally couple the third light 32 to the first power module 14 to indicate the activation of the brake system to the persons approaching the user from behind.

The control module 40 also is positioned to communicate the requests to couple the first light 18 and the second light 24 to the first power module 14. The controller 36 is positioned to selectively operationally couple the first light 18 and the second light 24 to the first power module 14. The first light 18 and the second light 24 are configured to blink to selectively indicate the user's intent to execute right turns and left turns to the persons approaching the user from behind.

In one embodiment, the controller 36 comprises a first housing 42 that defines an internal space 44. A first microprocessor 46 and a first receiver 48 are coupled to the first housing 42 and are positioned in the internal space 44. The first microprocessor 46 is operationally coupled to the first power module 14. The first receiver 48 is operationally coupled to the first microprocessor 46. The first receiver 48 is configured to communicate wirelessly.

The control module 40 comprises a second housing 50 that defines an interior space 52. A second power module 54, a second microprocessor 56, and a second transmitter 58 are coupled to the second housing 50 and are positioned in the interior space 52. The second microprocessor 56 is operationally coupled to the second power module 54. The second transmitter 58 is operationally coupled to the second microprocessor 56. The second transmitter 58 is configured to communicate wirelessly.

A left-turn button 60 and a right-turn button 62 are coupled to the second housing 50. The left-turn button 60 and the right-turn button 62 are depressible. The left-turn button 60 and the right-turn button 62 are operationally coupled to the second microprocessor 56.

In another embodiment, the second power module 54 comprises at least one second battery 64. In yet another embodiment, the first receiver 48 and the second transmitter 58 are Bluetooth-enabled.

In still yet another embodiment, a second receiver 66 and a first transmitter 68 are coupled to the first housing 42 and are positioned in the internal space 44. The second receiver 66 and the first transmitter 68 are operationally coupled to the first microprocessor 46. The second receiver 66 is global positioning system enabled. The second receiver 66 is configured to receive location coordinates of the user and to relay the location coordinates to the first microprocessor 46. The first transmitter 68 is configured to communicate wirelessly. The first microprocessor 46 is positioned to compel the first transmitter 68 to transmit the location coordinates of the user.

Each of a pair of fourth lights 70 is coupled to the shell 12. The fourth lights 70 are positioned singly on the back 22 and a front 72 of the shell 12 proximate to a top 74 of the shell 12. The fourth lights 70 are operationally coupled to the controller 36. The fourth lights 70 are configured to irregularly and intermittently illuminate, such that the fourth lights 70 are strobing. The controller 36 is positioned to selectively operationally couple the fourth lights 70 to the first power module 14. The fourth lights 70 are configured to selectively illuminate spaces proximate to the back 22 and the front 72 of the shell 12. In one embodiment, each fourth light 70 comprises a plurality of fourth light emitting diodes 76.

Each of a pair of fifth lights 78 is positioned singly on the right side 20 and the left side 26 of the shell 12 proximate to the top 74 of the shell 12. The fifth lights 78 are operationally coupled to the controller 36. The fifth lights 78 are configured to intermittently illuminate. The controller 36 is positioned to selectively operationally couple the fifth lights 78 to the first power module 14. The fifth lights 78 are configured to blink to increase the visibility of the user to persons who approach the user from either side. In one embodiment, each fifth light comprises a plurality of fifth light emitting diodes 80.

In use, the sensor 38 is positioned on the vehicle and is configured to detect activation of the brake system of the vehicle. The second microprocessor 56 is positioned to compel the second transmitter 58 to communicate the activation of the brake system of the vehicle to the first microprocessor 46 via the first receiver 48. The first microprocessor 46 is positioned to operationally couple the third light 32 to the first power module 14 to indicate the activation of the brake system to the persons approaching the user from behind. The left-turn button 60 and the right-turn button 62 are positioned to be selectively depressed to compel the second microprocessor 56 to compel the second transmitter 58 to communicate the left-turn signal and right-turn signal to the first microprocessor 46 via the first receiver 48. The first microprocessor 46 is positioned to selectively operationally couple the first light 18 and the second light 24 to the first power module 14. The first light 18 and the second light 24 are configured to blink to selectively indicate the user's intent to execute right turns and left turns to the persons approaching the user from behind. The controller 36 is positioned to selectively operationally couple the fourth lights 70 to the first power module 14. The fourth lights 70 are configured to selectively illuminate the spaces proximate to the back 22 and the front 72 of the shell 12. The controller 36 is positioned to selectively operationally couple the fifth lights 78 to the first power module 14. The fifth lights 78 are configured to blink to increase the visibility of the user to the persons approaching the user from either side.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An illuminated safety helmet assembly comprising:
a shell substantially complementary to a helmet that is configured for coupling to a head of a user, said shell being configured for coupling to the helmet;
a first power module coupled to said shell;
a first light coupled to and positioned on a right side of said shell proximate to a back of said shell;
a second light coupled to and positioned on a left side of said shell proximate to said back of said shell;
a third light coupled to and centrally positioned on said back of said shell;
a controller coupled to said shell, said controller being operationally coupled to said first power module, said first light, said second light, and said third light, said controller being configured for receiving commands from the user; and
wherein said controller is positioned for selectively operationally coupling said first light, said second light, and said third light, to said first power module such that the user is positioned for selectively indicating the user's intent to execute right turns and left turns and such that braking of a vehicle being operated by the user, such as a velocipede, is indicated to persons approaching the user from behind.

2. The assembly of claim 1, further including said shell being integral to the helmet.

3. The assembly of claim 1, further including said first power module comprising at least one first battery.

4. The assembly of claim 1, further including said first light and said second light being configured for intermittent illumination.

5. The assembly of claim 1, further including said first light and said second light being yellow, said third light being red.

6. The assembly of claim 1, further comprising:
said first light comprising a plurality of first light emitting diodes;
said second light comprising a plurality of second light emitting diodes; and
said third light comprising a plurality of third light emitting diodes.

7. The assembly of claim 1, further comprising:
a sensor configured for coupling to the vehicle, said sensor being configured for operationally coupling to a brake system of the vehicle, wherein said sensor is positioned on the vehicle such that said sensor is configured for detecting activation of the brake system of the vehicle;
a control module configured for coupling to the vehicle, said control module being operationally coupled to said sensor, said control module being configured for selectively inputting requests for coupling of said first light and said second light to said first power module, said control module being configured for communicating with said controller; and
wherein said control module is positioned on the vehicle such that said control module is positioned for receiving input from said sensor upon said sensor detecting the activation of the brake system of the vehicle, wherein said control module is positioned for communicating the activation of the brake system of the vehicle to said controller, wherein said controller is positioned for selectively operationally coupling said third light to said first power module for indicating the activation of the brake system to the persons approaching the user from behind, wherein said control module is positioned to communicate the requests for coupling of said first light and said second light to said first power module such that said controller is positioned for selectively operationally coupling said first light and said second light to said first power module such that said first light and said second light are configured for blinking for selectively indicating the user's intent to execute right turns and left turns to the persons approaching the user from behind.

8. The assembly of claim 7, further comprising:
said controller comprising:
a first housing defining an internal space,
a first microprocessor coupled to said first housing and positioned in said internal space, said first microprocessor being operationally coupled to said first power module, and
a first receiver coupled to said first housing and positioned in said internal space, said first receiver being operationally coupled to said first microprocessor, said first receiver being configured for wireless communication;
said control module comprising:
a second housing defining an interior space,
a second power module coupled to said second housing and positioned in said interior space,
a second microprocessor coupled to said second housing and positioned in said interior space, said second microprocessor being operationally coupled to said second power module,
a second transmitter coupled to said second housing and positioned in said interior space, said second transmitter being operationally coupled to said second microprocessor, said second transmitter being configured for wireless communication,
a left-turn button coupled to said second housing, said left-turn button being depressible, said left-turn button being operationally coupled to said second microprocessor, and
a right-turn button coupled to said second housing, said right-turn button being depressible, said right-turn button being operationally coupled to said second microprocessor; and
wherein said sensor is positioned on the vehicle such that said sensor is configured for detecting activation of the brake system of the vehicle, wherein second microprocessor is positioned for compelling said second transmitter for communicating the activation of the brake system of the vehicle to said first microprocessor via said first receiver, wherein said first microprocessor is positioned for operationally coupling said third light to said first power module for indicating the activation of the brake system to the persons approaching the user from behind, and said left-turn button and said right-turn button are positioned on said second housing such that said left-turn button and said right-turn button are positioned for selectively depressing for compelling said second microprocessor for compelling said second transmitter for communicating the left-turn signal and right-turn signal to said first microprocessor via said first receiver, wherein said first microprocessor is positioned for selectively operationally coupling said first light and said second light to said first power module such that said first light and said second light are configured for blinking for selectively indicating the user's intent to execute right turns and left turns to the persons approaching the user from behind.

9. The assembly of claim 8, further including said second power module comprising at least one second battery.

10. The assembly of claim 8, further including said first receiver and said second transmitter being Bluetooth-enabled.

11. The assembly of claim 8, further comprising:
a second receiver coupled to said first housing and positioned in said internal space, said second receiver being operationally coupled to said first microprocessor, said second receiver being global positioning system enabled;
a first transmitter coupled to said first housing and positioned in said internal space, said first transmitter being operationally coupled to said first microprocessor, said first transmitter being configured for wireless communication; and
wherein said second receiver is positioned in said first housing such that said second receiver is configured for receiving location coordinates of the user and for relaying the location coordinates to said first microprocessor, wherein said first microprocessor is positioned for compelling said first transmitter for transmitting the location coordinates of the user.

12. The assembly of claim 1, further including a pair of fourth lights coupled to said shell, said fourth lights being positioned singly on said back and a front of said shell proximate to a top of said shell, said fourth lights being operationally coupled to said controller, said fourth lights being configured for irregular intermittent illumination, such that said fourth lights are strobing, wherein said fourth lights are positioned on said shell such that said controller is positioned for selectively operationally coupling said fourth lights to said first power module, wherein said fourth lights are configured for selectively illuminating spaces proximate to said back and said front of said shell.

13. The assembly of claim 12, further including each said fourth light comprising a plurality of fourth light emitting diodes.

14. The assembly of claim 1, further including a pair of fifth lights, said fifth lights being positioned singly on said right side and said left side of said shell proximate to a top of said shell, said fifth lights being operationally coupled to said controller, said fifth lights being configured for intermittent illumination, wherein said fifth lights are positioned on said shell such that said controller is positioned for selectively operationally coupling said fifth lights to said first power module, wherein said fifth lights are configured for blinking for increasing the visibility of the user to persons approaching the user from either side.

15. The assembly of claim 14, further including each said fifth light comprising a plurality of fifth light emitting diodes.

16. An illuminated safety helmet assembly comprising:
a shell substantially complementary to a helmet that is configured for coupling to a head of a user, said shell being configured for coupling to the helmet, said shell being integral to the helmet;
a first power module coupled to said shell, said first power module comprising at least one first battery;
a first light coupled to and positioned on a right side of said shell proximate to a back of said shell, said first light being configured for intermittent illumination, said first light being yellow, said first light comprising a plurality of first light emitting diodes;
a second light coupled to and positioned on a left side of said shell proximate to said back of said shell, said second light being configured for intermittent illumination, said second light being yellow, said second light comprising a plurality of second light emitting diodes;
a third light coupled to and centrally positioned on said back of said shell, said third light being red, said third light comprising a plurality of third light emitting diodes;
a controller coupled to said shell, said controller being operationally coupled to said first power module, said first light, said second light, and said third light, said controller being configured for receiving commands from the user such that said controller is positioned for selectively operationally coupling said first light, said second light, and said third light, to said first power module such that the user is positioned for selectively indicating the user's intent to execute right turns and left turns and such that braking of a vehicle being operated by the user, such as a velocipede, is indicated to persons approaching the user from behind, said controller comprising:
a first housing defining an internal space,
a first microprocessor coupled to said first housing and positioned in said internal space, said first microprocessor being operationally coupled to said first power module,
a first receiver coupled to said first housing and positioned in said internal space, said first receiver being operationally coupled to said first microprocessor, said first receiver being configured for wireless communication, said first receiver being Bluetooth-enabled,
a second receiver coupled to said first housing and positioned in said internal space, said second receiver being operationally coupled to said first microprocessor, said second receiver being global positioning system enabled, wherein said second receiver is positioned in said first housing such that said second receiver is configured for receiving location coordinates of the user and for relaying the location coordinates to said first microprocessor, and
a first transmitter coupled to said first housing and positioned in said internal space, said first transmitter being operationally coupled to said first microprocessor, said first transmitter being configured for wireless communication, wherein said first microprocessor is positioned for compelling said first transmitter for transmitting the location coordinates of the user;
a pair of fourth lights coupled to said shell, said fourth lights being positioned singly on said back and a front of said shell proximate to a top of said shell, said fourth lights being operationally coupled to said controller, said fourth lights being configured for irregular intermittent illumination, such that said fourth lights are strobing, wherein said fourth lights are positioned on said shell such that said controller is positioned for selectively operationally coupling said fourth lights to said first power module, wherein said fourth lights are configured for selectively illuminating spaces proximate to said back and said front of said shell, each said fourth light comprising a plurality of fourth light emitting diodes;
a pair of fifth lights, said fifth lights being positioned singly on said right side and said left side of said shell proximate to said top of said shell, said fifth lights being operationally coupled to said controller, said fifth lights being configured for intermittent illumination, wherein said fifth lights are positioned on said shell such that said controller is positioned for selectively operationally coupling said fifth lights to said first power module, wherein said fifth lights are configured for blinking for increasing the visibility of the user to persons approaching the user from either side, each said fifth light comprising a plurality of fifth light emitting diodes;
a sensor configured for coupling to the vehicle, said sensor being configured for operationally coupling to a brake system of the vehicle, wherein said sensor is positioned on the vehicle such that said sensor is configured for detecting activation of the brake system of the vehicle;
a control module configured for coupling to the vehicle, said control module being operationally coupled to said sensor, said control module being configured for selectively inputting requests for coupling of said first light and said second light to said first power module, said control module being configured for communicating with said controller, wherein said control module is positioned on the vehicle such that said control module is positioned for receiving input from said sensor upon said sensor detecting the activation of the brake system of the vehicle, wherein said control module is positioned for communicating the activation of the brake system of the vehicle to said controller, wherein said controller is positioned for selectively operationally coupling said third light to said first power module for indicating the activation of the brake system to the persons approaching the user from behind, wherein said control module is positioned to communicate the requests for coupling of said first light and said second light to said first power module such that said controller is positioned for selectively operationally coupling said first light and said second light to said first power module such that said first light and said second light are configured for blinking for selectively indicating the user's intent to execute right turns and left turns to the persons approaching the user from behind, said control module comprising:
a second housing defining an interior space,
a second power module coupled to said second housing and positioned in said interior space, said second power module comprising at least one second battery
a second microprocessor coupled to said second housing and positioned in said interior space, said second microprocessor being operationally coupled to said second power module,
a second transmitter coupled to said second housing and positioned in said interior space, said second transmitter being operationally coupled to said second microprocessor, said second transmitter being configured for wireless communication, said second transmitter being Bluetooth-enabled,
a left-turn button coupled to said second housing, said left-turn button being depressible, said left-turn button being operationally coupled to said second microprocessor,
a right-turn button coupled to said second housing, said right-turn button being depressible, said right-turn button being operationally coupled to said second microprocessor; and
wherein said sensor is positioned on the vehicle such that said sensor is configured for detecting activation of the brake system of the vehicle, wherein second microprocessor is positioned for compelling said second transmitter for communicating the activation of the brake system of the vehicle to said first microprocessor via said first receiver, wherein said first microprocessor is positioned for operationally coupling said third light to said first power module for indicating the activation of the brake system to the persons approaching the user from behind, and said left-turn button and said right-turn button are positioned on said second housing such that said left-turn button and said right-turn button are positioned for selectively depressing for compelling said second microprocessor for compelling said second transmitter for communicating the left-turn signal and right-turn signal to said first microprocessor via said first receiver, wherein said first microprocessor is positioned for selectively operationally coupling said first light and said second light to said first power module such that said first light and said second light are configured for blinking for selectively indicating the user's intent to execute right turns and left turns to the persons approaching the user from behind, wherein said fourth lights are configured for selectively illuminating the spaces proximate to said back and said front of said shell, wherein said fifth lights are positioned on said shell such that said controller is positioned for selectively operationally coupling said fifth lights to said first power module, wherein said fifth lights are configured for blinking for increasing the visibility of the user to the persons approaching the user from either side.
